(19) United States
(12) Patent Application Publication
(10) Pub. No.: US 2014/0282415 A1
(43) Pub. Date: Sep. 18, 2014

(54) METHOD AND SYSTEM FOR DEBUGGING A PROGRAM

(71) Applicant: CADENCE DESIGN SYSTEMS, INC., San Jose, CA (US)

(72) Inventors: Meir OVADIA, Rosh Ha-Ayin (IL); Rodion MELNIKOV, Modiin (IL)

(73) Assignee: Cadence Design Systems, Inc., San Jose, CA (US)

(21) Appl. No.: 13/804,434

(22) Filed: Mar. 14, 2013

(51) Int. Cl. G06F 11/36

(52) U.S. Cl. CPC G06F 11/362
USPC 717/125

(57) ABSTRACT

A computer-implemented method and system for debugging a program is disclosed. The method may include obtaining data on inter-component calls of a call chain of an execution run of the program between segments of Multilanguage software components of the program, the data relating to the identity of the Multilanguage software components in which these segments are included and an order in which the segments are called in the call chain. The method may further include obtaining a user selection relating to one of the segments of the Multilanguage software components that were called in the call chain. The method may also include invoking a debugger designed for debugging the software component of the Multilanguage software components that includes the selected segment and displaying a user interface of that debugger on a display device.

### BACKGROUND

Debugging is a methodological process in which a technician systematically searches for anomalies or discrepancies (hereinafter—anomalies) in a computer program or an electronic hardware component, and fixes them.

Typically, debugging extends from finding and fixing small errors to lengthy and tedious data collecting, analysis and scheduling updates.

Debugging involves human skills and typically depends on the programming language use and the available debugging tools (also referred to as—debuggers).

### SUMMARY

There is thus provided, in accordance with embodiments, a computer-implemented method of debugging a program. The method may include obtaining data on inter-component calls of a call chain of an execution run of the program between segments of Multilanguage software components of the program, the data relating to the identity of the Multilanguage software components in which these segments are included and an order in which the segments are called in the call chain. The method may also include obtaining a user selection relating to one of the segments of the Multilanguage software components that were called in the call chain. The method may further include invoking a debugger designed for debugging the software component of the Multilanguage software components that includes the selected segment and causing a user interface of the debugger to be displayed on a display device.

According to some embodiments, the method may include displaying on a display device information on the order in which the segments are called in the call chain.

In some embodiments the method may also include maintaining a stack of records corresponding to the inter-component calls in a chronological order.

In some embodiments the stack may be displayed on the display device.

According to embodiments the method may include issuing notifications on incoming and outgoing calls for each of the Multilanguage software components.

In some embodiments the method may include providing an application program interface for each of the Multilanguage software components for issuing the notifications on the incoming and outgoing calls for that Multilanguage software component.

According to embodiments the method may include executing the call chain in step debugging.

According to some embodiments there is provided a system for debugging a program. The system may include a processing unit configured to obtain data on inter-component calls of a call chain of an execution run of the program between segments of Multilanguage software components of the program, the data relating to the identity of the Multilanguage software components in which these segments are included and an order in which the segments are called in the call chain. The processing unit may be configured to obtain a user selection relating to one of the segments of the Multilanguage software components that were called in the call chain and invoke a debugger designed for debugging the software component of the Multilanguage software components that includes the selected segment.

In accordance with embodiments, a non-transitory computer readable medium for debugging a program is provided, having instructions stored thereon, which when executed by a processing unit cause the processing unit to perform the method of: obtaining data on inter-component calls of a call chain of an execution run of the program between segments of Multilanguage software components of the program, the data relating to the identity of the Multilanguage software components in which these segments are included and an order in which the segments are called in the call chain; obtaining a user selection relating to one of the segments of the Multilanguage software components that were called in the call chain; and invoking a debugger designed for debugging the software component of the Multilanguage software components that includes the selected segment and causing a user interface of the debugger to be displayed on the display device.

### BRIEF DESCRIPTION OF THE DRAWINGS

FIG. 1A illustrates a call chain, involving multilanguage software components, which involves several call-chain segments from software components of different languages;

FIG. 1B illustrates three Multilanguage software components whose segments participate in the call chain shown in FIG. 1A;

FIG. 2 illustrates a method 200 for debugging a program, in accordance with an embodiment;

FIG. 3 illustrates a stack of inter-component call records that includes collected information on the inter-component calls for a certain call chain of an execution run, according to an embodiment;

FIG. 4 illustrates a system for debugging a program according to an embodiment.

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

A debugger typically allows a programming expert (hereinafter—programmer) to follow the execution of a software program or an electronic hardware component (hereinafter, for brevity—program) and detect anomalies. In some cases, automatic debugging may be performed by the debugger, but essentially, a human programmer is needed to monitor and intervene in the debugging process. Typically a debugger displays a source code or assembly code of the program under test on a graphical user interface (hereinafter referred to as GUI). The debugger includes functions, such as performing break point setting, step execution, and the like. For example, in step execution using the GUI, the debugger executes one line of the source code or one instruction of the assembly code, and if there is a problematic code which leads to an error in a result of execution of the one instruction of the source code or assembly code, the debugger highlights a problematic portion or displays an auxiliary code, message, or the like which represents details of the error. Accordingly, the programmer can easily find the problematic code.

Many debuggers have been introduced, which are typically dependant on the programming language to which they relate. While such debuggers handle well debugging of a call chain within a single process that was designed using a certain programming language, a problem may arise in the case of a program that involves a plurality (e.g. two or more) of software components based on different languages. In such a case, a language-dependant debugger may not be apt for the task.

There are known debuggers of various types. Some are specifically designed to debug computer programs written in a specific programming language. Others are designed to handle specific libraries. Other debuggers are designed to be used in connection with specific programming tools, while some debuggers are designed to handle programs of specific vendors.

In the context of the present specification, “language” is a broad term that may refer to a specific programming language, specific language engine, specific platform, specific library, specific programming tool (e.g. an assignment generator, memory modeler, coverage collector, temporal assumption checker, etc.) specific vendor, or specific logic, all of which have certain user logic in them and that can be parts (hereinafter—“software components of different languages”, or “multilanguage software components”) of a program being debugged.

Multilanguage software components can pose a real challenge to debugging. When a call chain crosses multilanguage software components there is typically no way to clearly view it or debug it as a whole using existing debuggers. The reason for it is that each debugger directed to a specific component of the multilanguage software components has a view limited to its state only, while the logic of a call chain may not be enclosed in any single one of them separately. Some typical problem: how to move up/down the stack, especially when a call chain crosses back and forth between two multilanguage software components or when a call chain crosses between several multilanguage software components; how to continue stepping in, when during a debugging execution of one software component a call is generated by that software component to another software component of a different language, or when a call finishes and folds down to another component that has caused the debugged call; when a multilanguage software components execution thread is present; etc.

There are some known debugging tools which solve the multilanguage problem by fully integrating debuggers designed for different languages. This may be possible when there is a singe compiler/debugger that has a full knowledge of all the different languages involved. However, such an approach may be impractical in some cases, if not in many, such as, for example, when software components of different vendors, different versions etc are involved.

In many cases (e.g. in verification environments) multilanguage software components may be involved, e.g. of different vendors, different versions etc. Even in case of a single vendor, an environment may contain extremely complex tools so different in nature, logic and paradigm, that creating a fully integrated debugger may be impractical. Some verification tools already have more than one debugger: for example, currently in Specman ‘e’ there is a completely separated run-time debugger, generation debugger, and also post-process debugger—all as separate products.

FIG. 1A illustrates a call chain 10 involving multilanguage software components, which involves seven call-chain segments (1-7). The call-chain represents a logical flow of a specific run (execution) of a program that includes the multilanguage software components shown in FIG. 1B (and perhaps also other software components which have not been called and are therefore not shown) up to a segment (7) that includes a break-point of that run. The arrows in FIGS. 1A and 1B represent inter-segment calls. i.e., calls from one segment of a certain software component to another software component. The last segment (7) of the call chain is the segment which includes a code line which is the break-point of that particular run that was chosen by a human programmer conducing the debugging of the program.

The seven segments (1-7) are in fact segments of three software components of different languages that are involved in call-chain 10. FIG. 1B illustrates three Multilanguage software components (MSCs) 12, 14 and 16 whose segments participate in the call chain shown in FIG. 1A. MSC 12 includes segments 1, 3 and 6, MSC 14 includes segments 2 and 5, and MSC 16 includes segments 4 and 7. Each segment may include one or a plurality of software code lines (typically more than one).

Each of the three Multilanguage software components 12, 14 and 16, may have its own dedicated debugger, which is designed to allow debugging of that component, but may not be useable for debugging the other MSCs.

According to embodiments a Multilanguage meta debugger (MMD) is proposed, which is a programming facility offering high-level debugging tools to user, and provides for an application-program interface (API) that allows each of software components designed for different languages to use its own dedicated debugger in a way that is practically transparent to the user.

FIG. 2 illustrates a method 200 for debugging a program, in accordance with an embodiment. Method 200 may include obtaining 20 data on inter-component calls of a call chain of an execution run of the program between segments of Multilanguage software components of the program, the data relating to the identity of the Multilanguage software components in which these segments are included and an order in which the segments are called in the call chain. Method 200 may also include obtaining 24 a user selection relating to one of the segments of the Multilanguage software components that were called in the call chain and invoking 26 a debugger designed for debugging the software component of the Multilanguage software components that includes the selected segment and displaying a user interface of that debugger on a display device.

In some embodiments information on the order in which the segments are called in the call chain may be displayed on the display device.

According to embodiments such a method may be administered by a MMD. The MMD may receive the data on inter-component calls of a call chain via a notification application-program interface (API).

In some embodiments, each of the MSCs of the program is configured to issue a notification (e.g. via an API) to the MMD. Here are some notifications that may be generated:
1) A notification on the commencement of an execution call chain; such notification may include, for example, identification information on the chain call, identification information on the MSC issuing this notification;
2) A notification on an incoming call from another MSC; such notification may include identification information on the chain call, identification information on the MSC issuing the incoming call, identification information on the MSC called, information on the addressed code within the MSC called, information on the location of the code within the MSC issuing the call, information on the stack location of either of the MSCs involved;
3) A notification on an outgoing call to another MSC; such notification may include identification information on the chain call, identification information on the MSC addressed by the outgoing call, identification information on the MSC issuing the call, information on the addressed code within the MSC called, information on the location of the code within the MSC issuing the call, information on the stack location of either of the MSCs involved;
4) A notification on a receipt of a return call from another MSC, responding to an outgoing call from that MSC; such notification may include identification information on the chain call, identification information on the MSC returning the call, identification information on the MSC receiving the return call, information on the addressed code within the MSC called, information on the location of the code within the MSC issuing the call, information on the stack location of either of the MSCs involved; typically, the parameters included in the notification would match the parameters notified in the notification relating to the outgoing call to which the return call responded;
5) A notification on issuing a return call to another MSC, responding to an outgoing call from that MSC; such notification may include identification information on the chain call, identification information on the MSC to which the call is returned, identification information on the MSC issuing the return call, information on the addressed code within the MSC called, information on the location of the code within the MSC issuing the call, information on the stack location of either of the MSCs involved; typically, the parameters included in the notification would match the parameters notified in the notification relating to the original call to which the return call responded;
According to embodiments, an MMD may maintain a stack of inter-component call records that includes collected information on the inter-component calls for a certain call chain of an execution run. Such a stack is illustrated in FIG. 3.

MMD stack 30 may include representing an abstract view on an executed MSC call chain cross between MSCs. In the example shown in FIG. 3, stack 30 includes stacked entries, representing the direction of flow of the inter-component call chain. In this example the entries are arranged in a chronological order going from the bottom and up to the top of the stack. Thus, the illustrated stack holds the following records: a record of the start 32 of the inter-component chain at component X, a record of an outgoing call 33 of component X made at location Z within that component, a record of an incoming call 34 to component X1, at location Z1 within that component, a record of an outgoing call 35 from component X1, at location Z2 within that component, a record of an incoming call 36 to component X2, at location Z3 within that component, a record of an outgoing call 37 from component X2, at location Z4 within that component, and a record of an incoming call 38 to component X3, at location Z5 within that component.

Such an MMD stack may provide the user with a high-level view on the state of the executed program, and also be used by the MMD for invoking the proper debugger designed for debugging the relevant software component of interest to the user. The user is thus allowed to move up and down the stack in the process of debugging the program while crossing multilanguage boundaries.

According to embodiments, a debugging service API may be implemented, for use by MSCs during a debugging process, to allow MMD to invoke the proper debugger which is associated with the segment of interest to the user, based on saved information

According to embodiments, upon reaching a stop state of the execution (e.g., when a break-point is reached) a stack showing a stacked arrangement of records of inter-component calls, in the chronological order in which the MSCs are called in the call chain may be presented, for example by displaying it on a display device.

According to embodiments the MMD may offer various functionalities, using the information of the stack, such as, for example:
a) show external caller frame view; this view may be provided, for example, when a user, while viewing a routine/method frame in the user interface of a current debugger of a current MSC requests to view a caller routine/method frame in that MSC which calls a routine/method frame at another MSC (next MSC in the call chain); the MMD would refer to the stack to look for an outgoing call generated from the present routine/method frame to another MSC and present it;
b) show called out frame view; this view may be provided, for example, when a user, while viewing a routine/method frame in the user interface of a current debugger of a current MSC requests to view a routine/method frame of another MSC that is called from the present routine/method frame; the MMD would refer to the stack to look for the outgoing call relating to the current MSC and the corresponding incoming call at the next MSC in the call chain, and invoke the debugger associated with the next MSC to display the called frame at that MSC;
c) show a calling external frame view; this view may be provided, for example, when a user, while viewing a routine/method frame in the user interface of a current debugger of a current MSC requests to view a routine/method frame of another MSC that called the present routine/method frame; the MMD would refer to the stack to look for the incoming call relating to the current MSC and the corresponding outgoing call at the previous MSC in the call chain, and invoke the debugger associated with the previous MSC to display the calling frame at that MSC;
d) show an entering frame; this view may be provided, for example, when a user, while viewing a routine/method frame in the user interface of a current debugger of a current MSC requests to view a called routine/method frame in that MSC which was called by a routine/method frame at another MSC (previous MSC in the call chain); the MMD would refer to the stack to look for an incoming call at the present routine/method frame from another MSC and present it;

In some embodiments step debugging may be carried out with a functionality of the MMD that facilitates crossing from a certain segment of a current MSC to another segment of the next MSC that is called by the segment of the current MSC, by skipping from the debugger associated with the current MSC into the debugger associated with the next MSC. For example, a functionality of an MMD, according to embodiments would include a command of “step into external code”, which causes the MMD to invoke the other debugger, stepping to the next addressed code of the other MSC. Typically, such functionality may be paired with a notification on an outgoing call to another MSC (see hereinabove).

In some embodiments step debugging mode may be offered, which is managed by the MMD. The current debugger would issue a “step into external code” command when a user debugs a code of a current MSC and wishes to step out into a call to an external code (of another MSC). Such a command would typically be associated with a notification on an outgoing call to another MSC (see hereinabove), that would cause the MMD to invoke the debugger of the next MSC. If the current debugger issues a “step over” command then the external code would be executed without stepping.

In some embodiments the current debugger may issue a “step into external caller” command when a user debugs while stepping, finishes debugging a frame which was called from an external code (another MSC) and wants to continue step debugging into the external frame that called the current frame. Such a command would typically be associated with a notification on an outgoing call to another MSC (see hereinabove), that would cause the MMD to invoke the debugger of the next MSC.

In some embodiments, after the MMD receives either a “step into external code” command with a notification on an outgoing call to another MSC or a “step into external caller” command with a notification on an outgoing call to another MSC, it notifies the MSC to which execution is passed that a “step debugging” is carried out. This notification by the MMD is issued after the MMD receives a notification from that MSC about a call received by that MSC.

The stack maintained by the MMD according to embodiments, allows the user to zoom into a specific code in the call chain, opening it with the debugger associated with the MSD that code is part of; and also facilitates some break/trace facilities on recorded changes in the stack state. For asynchronous Parallel environments, such as multi-thread, multi-process, distributed or client-server, there would be a addition to the API which enables the MMD to associate a notification with the proper call chain (each call chain would have its own stack). There are standard ways to implement this: hierarchical network identifier, host name/ID, process ID, call chain ID.

A MMD according to embodiments may work even in the case when not all MSCs involved are equipped with a proper API. If some of the MSCs involved in a call chain do not include such API, its information will not be included in the maintained stack, so the MMD would regard it as an unknown layer in the call chain, yet still allowing the user to inspect MSC that offer the required API on the same call chain.

Implementing embodiments does not require the use of a unified debugger, the use of a same complier. Such requirements are hard to satisfy even when dealing with different MSCs of the same vendor, and are typically practically impossible to satisfy when dealing with different MSCs of different vendors. According to embodiments a MMD does not limit debugging the same process, the same machine. Furthermore, it allows gradual adoption, when only some of the MSCs are configured to cooperate with a MMD, later to be joined by more and more vendors configuring their MSCs to communicate with a MDD.

FIG. 4 illustrates a system 40 for debugging a program according to an embodiment. System 40 may include a processing unit 42 (e.g. one or a plurality of processors, on a single machine or distributed on a plurality of machines) for executing a debugging method according to embodiments. Processing unit 42 may be linked with memory 46 on which a program implementing a method according to embodiments and corresponding data may be loaded and run from, and storage device 48, which is a non-transitory computer readable medium (or mediums) such as, for example, one or a plurality of hard disks, flash memory devices, etc. on which a program implementing a method according to embodiments and corresponding data may be stored. System 40 may further include display device 44 (e.g. CRT, LCD, LED etc.) on which one or a plurality user interfaces associated with a program implementing a method according to embodiments and corresponding data may be presented. System 40 may also include input device 41, such as, for example, one or a plurality of keyboards, pointing devices, touch sensitive surfaces (e.g. touch sensitive screens), etc. for allowing a user to input commands and data.

Methods and systems according to embodiments may be used in various debugging scenarios, such as, for example debugging of circuit designs and other like language or context to plant support for electronic design applications, as well as other kinds of program debugging.

Examples may be embodied in the form of a system, a method or a computer program product. Similarly, examples may be embodied as hardware, software or a combination of both. Examples may be embodied as a computer program product saved on one or more non-transitory computer readable medium (or mediums) in the form of computer readable program code embodied thereon. Such non-transitory computer readable medium may include instructions that when executed cause a processor to execute method steps in accordance with examples. In some examples the instructions stores on the computer readable medium may be in the form of an installed application and in the form of an installation package.

Such instructions may be for example loaded into one or more processors and executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer, or on a plurality of computers.

Examples are described hereinabove with reference to flowcharts and/or block diagrams depicting methods, systems and computer program products according to examples.

Features of various examples discussed herein may be used with other embodiments discussed herein. The foregoing description of the embodiments has been presented for the purposes of illustration and description. It is not intended to be exhaustive or to be limiting to the precise form disclosed. It should be appreciated by persons skilled in the art that many modifications, variations, substitutions, changes, and equivalents are possible in light of the above teaching.

We claim:

1. A computer-implemented method of debugging a program comprising:
obtaining data on inter-component calls of a call chain of an execution run of the program between segments of Multilanguage software components of the program, the data relating to the identity of the Multilanguage software components in which these segments are included and an order in which the segments are called in the call chain;
obtaining a user selection relating to one of the segments of the Multilanguage software components that were called in the call chain; and
invoking a debugger designed for debugging the software component of the Multilanguage software components that includes the selected segment and causing a user interface of the debugger to be displayed on a display device.

2. The method of claim 1, further comprising displaying on a display device information on the order in which the segments are called in the call chain.

3. The method of claim 2, further comprising maintaining a stack of records corresponding to the inter-component calls in a chronological order.

4. The method of claim 3, wherein the stack is displayed on the display device.

5. The method of claim 1, further comprising issuing notifications on incoming and outgoing calls for each of the Multilanguage software components.

6. The method of claim 5, further comprising providing an application program interface for each of the Multilanguage software components for issuing the notifications on the incoming and outgoing calls for that Multilanguage software component.

7. The method of claim 1, further comprising executing the call chain in step debugging.

8. A system for debugging a program, comprising a processing unit configured to obtain data on inter-component calls of a call chain of an execution run of the program between segments of Multilanguage software components of the program, the data relating to the identity of the Multilanguage software components in which these segments are included and an order in which the segments are called in the call chain, and wherein the processing unit is configured to obtain a user selection relating to one of the segments of the Multilanguage software components that were called in the call chain and invoke a debugger designed for debugging the software component of the Multilanguage software components that includes the selected segment.

9. The system of claim 8, wherein the processing unit is configured to cause information on the order in which the segments are called in the call chain to be displayed on a display device.

10. The system of claim 8, wherein the processing unit is configured to maintain a stack of records corresponding to the inter-component calls in a chronological order.

11. The system of claim 10, wherein the processing unit is configured to cause the stack to be displayed on a display device.

12. The system of claim 8, wherein the processing unit is configured to issue notifications on incoming and outgoing calls for each of the Multilanguage software components.

13. The system of claim 12, wherein the processing unit is configured to execute an application program interface for each of the Multilanguage software components for issuing the notifications on the incoming and outgoing calls for that Multilanguage software component.

14. The system of claim 8, wherein the processing unit is configured to execute the call chain in step-debugging.

15. A non-transitory computer readable medium for debugging a program having instructions stored thereon, which when executed by a processing unit cause the processing unit to perform the method of:
obtaining data on inter-component calls of a call chain of an execution run of the program between segments of Multilanguage software components of the program, the data relating to the identity of the Multilanguage software components in which these segments are included and an order in which the segments are called in the call chain;
obtaining a user selection relating to one of the segments of the Multilanguage software components that were called in the call chain; and
invoking a debugger designed for debugging the software component of the Multilanguage software components that includes the selected segment and causing a user interface of the debugger to be displayed on a display device.

16. The non-transitory computer readable medium of claim 15, having further instructions stored thereon, which when executed by a processing unit cause the processing unit to maintain a stack of records corresponding to the inter-component calls in a chronological order.

17. The non-transitory computer readable medium of claim 16, having further instructions stored thereon, which when executed by a processing unit cause the processing unit to cause the stack to be displayed on the display device.

18. The non-transitory computer readable medium of claim 16, having further instructions stored thereon, which when executed by a processing unit cause the processing unit to issue notifications on incoming and outgoing calls for each of the Multilanguage software components.

19. The non-transitory computer readable medium of claim 18, having further instructions stored thereon, which when executed by a processing unit cause the processing unit to execute the call chain in step-debugging.
